(19) United States
(12) Patent Application Publication
(10) Pub. No.: US 2003/0139952 A1
(43) Pub. Date: Jul. 24, 2003

(54) Complexity management and production optimization system

(75) Inventors: John Julius Lubash, Northville, MI (US); Alan Edward Hyrila, Northville, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Global Technologies, Inc., Dearborn, MI

(21) Appl. No.: 09/683,608

(22) Filed: Jan. 24, 2002

(51) Int. Cl. G06F 17/60

(52) U.S. Cl. 705/7; 705/8

(57) ABSTRACT

A complexity management and production optimization system 10 is disclosed for use within a manufacturing facility 12 having a computer system 28, data acquisition assemblies 22, 24, 26 and a notification assembly 30. The computer 28 creates a dynamically modifiable schedule based on unique input variables and available resources such as customer orders 125 and the data received from the data acquisition assemblies 22, 24, and 26. The system 10 communicates any modification to the production schedule to the appropriate production facility employees via a notification assembly 30.

### BACKGROUND OF INVENTION

The present invention generally relates to a complexity management and production optimization system. More particularly, the present invention relates to a computer based system which analyzes multiple inputs, variables and constraints and uses these in combination with demand information to periodically or continuously modify a demand schedule, effective to allow the demands to be met within the constraints present and in accordance with unique input variables.

Ideally, business enterprises wish to optimize its business processes to maximize throughput while minimizing cost and delay. Typically, these processes must account for a plurality of unique input variables and available resources in developing a demand schedule for the end product or output. For example, a manufacturing facility capable of building several uniquely designed parts or assemblies having many different part options (“complexity”) may require several different operators having very specific training or other information on the fabrication of the desired part. The availability of these trained operators (“available resources”), their absence or vacation schedules, the amount of raw materials needed for fabrication, etc., (“unique input variables”) must be taken into account in developing and modifying a demand schedule. Likewise, a shipping facility needs to know the number and sizes of payloads of its trucks, final destinations and preferred routes the trucks will take, the availability of operators qualified to drive the various trucks and many other uniquely identifiable inputs and available resources to develop an optimized demand schedule of delivery.

As a further example, a conventional business enterprise obtains customer orders for uniquely described items (“complexity”) and communicates these orders to its manufacturing plants or production facilities in order to allow the orders to be “filled” (i.e., to allow the demanded products to be manufactured and shipped to its customers). Typically, these orders are generally placed within a production queue in a position only partially defined or determined by the respective date that each order was received or placed within the queue by use of a scheduling algorithm. Conventionally, the scheduling algorithm analyzes the received orders in combination with the respective components that each order requires and, based upon this analysis, places each of the received orders in a certain position within the production queue.

While this approach does initially allow production scheduling to be optimally achieved according to some predetermined optimization parameters (e.g., the highest margin units may be built first and substantially similar units are built or produced in a substantially contiguous group, thereby reducing the need to change tooling), this approach does not easily allow the production schedule to be dynamically changed or updated in response to the ever changing conditions of the production environment and does not easily allow the production schedule to be periodically and/or continuously optimized based upon these ever changing production conditions.

### SUMMARY OF INVENTION

It is a first non-limiting advantage of the present invention to provide a complexity management system that manages a plurality of unique input variable and available resources to provide an optimized output.

It is a further non-limiting advantage of the present invention to provide a production optimization system that periodically and/or continuously modifies a production schedule in accordance with monitored changes in the production environment.

According to one aspect of the present invention, a complexity management system is provided for developing a demand schedule taking into consideration a plurality of unique input variables, available resources and the manners in which they change during use. Particularly, the complexity management system includes a first portion which selectively generates a demand schedule and a second portion which monitors the unique input variables and the available resources. The second portion generates a signal and sends it to the first portion, based upon the monitoring of the input variables and available resources, effective to cause the demand schedule to be modified dynamically in a certain manner so as to optimize the output.

According to another aspect of the present invention, a production optimization system is provided for use with a production facility of the type adapted to create products by the use of certain materials and certain production assemblies. Particularly, the production optimization system includes a first portion which selectively generates a production schedule and a second portion which monitors the production assemblies and materials. The second portion generates a signal to the first portion, based upon the monitoring of the production assemblies and material, effective to cause the production schedule to be modified in a certain manner.

According to another aspect of the present invention, a method is provided for producing products by the use of various material and assemblies. The method includes the steps of creating a production schedule, monitoring the material and assemblies, and dynamically modifying the production schedule in response to the monitoring of the material and the assemblies.

These and other features, aspects, and advantages of the present invention will become apparent from a reading of the following detailed description of the preferred embodiment of the invention and by reference to the following drawings.

### BRIEF DESCRIPTION OF DRAWINGS

FIG. 1 is a block diagram of a production optimization system which is made in accordance with the teachings of the preferred embodiment of the invention and which is shown operatively used in combination with a conventional production system.

FIG. 2 is a schematic diagram of a first portion of the production optimization system which is shown in FIG. 1 and the material inventory assembly which is shown in FIG. 1.

FIG. 3 is a schematic diagram of a second portion of the production optimization system which is shown in FIG. 1 and the material transport and manufacturing/production assemblies which are shown in FIG. 1.

FIG. 4 is a diagrammatic view of an icon which is created by the notification assembly which is shown in FIG. 1.

### DETAILED DESCRIPTION

For ease in understanding, the present invention will be described in the context of a production facility for producing assemblies made from many combinations of parts and sub-parts. However, the present invention is not limited by this example. The present invention can be used in any system or process in which a plurality of unique input variables and available resources are used and monitored by a demand schedule to optimize the output of the system. Examples of non-limiting uses of the complexity management system of the present invention include optimizing the fabrication of parts or scheduling the production of an assembly based on unique input variables such as quantity and dates required, amount of complex parts needed as well as the availability, in real time, of specially trained operators. The present invention also can be used to develop an optimized shipping schedule involving unique input variables such as required payload size, delivery due dates, types of material being shipped as well as the available resources such as availability of multiple trucks and trained operators. The present invention is also useful in optimizing traffic flow paths through crowded intersections or through checkpoints having such unique inputs as number of operators at the checkpoints, numbers of each types of vehicles to be checked (passenger vehicles versus loaded parts vehicles) and available resources such as number of checkpoint stations and trained operators for each type of vehicle.

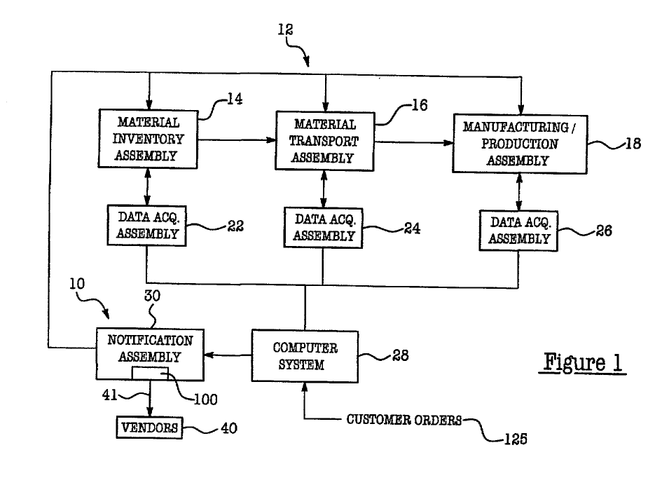

Referring now to FIG. 1, there is shown a production optimization system 10 made in accordance with the teachings of the preferred embodiment of the invention and which is being used in operative combination with a conventional production or manufacturing assembly or facility 12. As used in this specification, the term “optimize” means to substantially and automatically control the manufacturing or product creation process according to some predetermined criteria or plurality of unique input variables which may vary in their respective degree of importance.

Particularly, production or manufacturing assembly or facility 12 includes a material inventory portion or assembly 14, a material transport portion or assembly 16, and a manufacturing/production portion or assembly 18. As shown, the material inventory assembly 14 is “operatively coupled” to the material transport assembly 16. Particularly, the term “operatively coupled” means that portion or assembly 14 provides material or components/assemblies, in some manner, to the portion or assembly 16. Further, the term “material” means available resources such as raw material, components, devices, assemblies, partially formed and/or created assemblies, or any other tangible item needed to manufacture or create a certain item or good. Similarly, the material transport assembly or portion 16 is “operatively coupled” to the manufacturing and production assembly portion 18. It should be realized that the invention is not limited to a certain type or architecture of a production or manufacturing facility or system but has a substantially wide applicability to a diverse range of manufacturing or production facilities or systems.

Production optimization system 10 includes data acquisition assemblies 22, 24, and 26 which are respectively, operatively, and communicatively coupled to the material inventory portion or assembly 14, to the material transport portion or assembly 16, and to the manufacturing/production portion or assembly 18. In one non-limiting embodiment of the invention, data acquisition assemblies 22, 24, and 26 are substantially identical although they may, in other non-limiting embodiments, be quite dissimilar.

Further, production optimization system 10 includes a computer system 28 or a controller which is operable under stored program control. The computer system 28 may, in one non-limiting embodiment of the invention, comprise a conventional and commercially available computer which is created by the IBM Corporation of Armonk, N.Y. or a conventional and commercially programmable logic controller. Computer system 28, in another non-limiting embodiment, may also include several computers which are tasked with providing a certain function and which cooperatively provide the functionality which is described within this description. As shown, computer system 28 is communicatively and controllably coupled to the data acquisition assemblies 22, 24, and 26. Further, the production optimization system includes a notification assembly 30 which, in one non-limiting embodiment of the invention, is communicatively coupled to the material inventory portion or assembly 14, to the material transport portion or assembly 16, and to the manufacturing/production portion or assembly 18. In one non-limiting embodiment of the invention, the notification assembly 30 is operatively embedded within the computer system 28 and is communicatively coupled to material supply vendors 40, such as and without limitation by use of a global communications network 41.

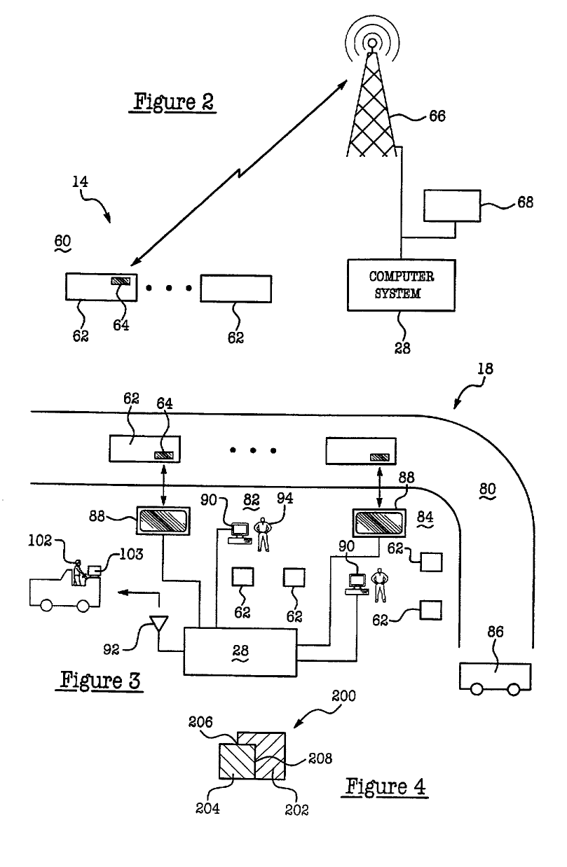

Referring now to FIG. 2, there is shown one non-limiting embodiment of a material inventory portion or assembly 14. Particularly, material inventory portion or assembly 14 includes at least one storage area 60 which contains various components or raw materials (i.e., “materials” or “available resources”) 62 which are needed to selectively create the desired goods or items 86. Each unique component or “piece” of raw material 62, in this non-limiting embodiment, carries or contains a selectively readable identification tag 64. By way of example and without limitation, the identification tag 64 may comprise a radio frequency identification tag or some other selectively readable tag such as that used by an optical bar code type scanner assembly. By way of further example, the “tag” can be an employee identification badge listing the unique qualities and training for that employee. The tag could also be placed on or integrated into vehicles so that a system for optimizing shipping schedules or vehicles through checkpoints can be easily identified, quantified and tracked in real time.

Further, the material inventory portion or assembly 14 includes a radio frequency antenna 66 communicatively coupled to a radio frequency transmitter/receiver assembly 68 and the assembly 68 is communicatively coupled to the computer system 28.

Each of the tags 64, in one non-limiting embodiment of the invention, uniquely identify the type of component (e.g., engine assembly) or material (e.g., sheet metal) upon which each tag 64 is respectively placed. Computer system 28, by use of the radio transmitter and receiver unit 68 selectively interrogates each of the tags 64, thereby acquiring knowledge of the types of material 62 which are located in the storage facility 60 along with the respective location of each of the material or components 62 within the storage facility 60, thereby acquiring knowledge of the inventory levels within the facility 12. Computer system 28, by use of the radio transmitter/receiver assembly 68 also interrogates the tags 64, effective to determine the location and the “flow” of each of the material or components 62 within the facility 12. In this one non-limiting embodiment of the invention, tags 64 in combination with radio transmitter/receiver and antenna 66 cooperatively comprise the data acquisition assembly 22.

Referring now to FIG. 3, there is shown one non-limiting example of a manufacturing/production assembly 18 which may be used in combination with the production optimization system 10 of the preferred embodiment of the invention. Particularly, the manufacturing/production assembly 18 includes a conveyor assembly 80 upon which some of the material or components 62 (e.g., a vehicular chassis) are selectively placed and which is effective to move the material or components 62 from one work station 82 to another work station 84, in order to allow a final product 86 (e.g., such as a vehicle) to be created. Other portions or types of components or materials 62 are located at or within various workstations 82, 84. The assembly 18 may further include readers 88 which are adapted to “read” or interrogate the tags 64 and to identify the presence of the material or component 62 in respectively close proximity to these readers 88. The information from the readers 88 is communicated to the computer system 28, effective to allow the computer system 28 to determine the location of each of the components and materials 62 upon the conveyor assembly 80. In this non-limiting embodiment, readers 88 cooperate with the tag 64 to form the data acquisition assembly 24. In another non-limiting embodiment of the invention, the previously delineated data acquisition assembly 22 may also provide information and operate in a substantially similar manner as does data acquisition assembly 24, thereby obviating the need for data acquisition assembly 24. Moreover, if both assemblies 22, 24 are used, one of the assemblies 22, 24 may provide a “check” for the other and conflicts may be resolved by the assembly 22, 24 “closest” to the actual material 62 whose location is desired to be obtained. For example, the data which is generated from the readers 88 may be used as a “check” for the data emanating from the assembly 22 since the antenna 66 is far removed from the material 62 which is upon the conveyor assembly 80.

The computer system 28 then uses this information to generate signals to display screens or monitors 90, effective to inform the assembly line personnel or assemblers 94 of the number and type of assemblies or components 62 which have yet to arrive to them by the conveyor assembly 80 and, by way of example and without limitation, the order that this material is to arrive at each of the workstations 82, 84. The system can provide a “look ahead”0 based on time (for example, fifteen minutes) or based on the number of parts in the queue (for example, 100 parts) to allow for advanced planning for timely part ordering and delivery as will be explained further below. In this manner, the assemblers 94 may quickly determine the amount or type of components 62 which they are to respectively utilize in upcoming assembly operations. The computer system 28 also may generate and transmit a signal, by use of an antenna 92 to an individual 102 having a pager 103 to bring certain components or materials 62 from the storage area 60 to the workstations 82, 84 in order to allow the assemblers 94 to have sufficient material or components 62 available to perform a desired assembly operation which are present upon the conveyor assembly 80. Thus, the system 10 provides an “early warning” to the inventory personnel 102 to provide needed materials 62 to the workstations 82, 84, before such material 62 is actually needed and allows for “optimal flow management” since the material 62 is brought to the workstations 82, 84 on an “as needed” basis and since only the actually needed material 62 is brought to these workstations 82, 84. This system can provide the operator with an exact number of the parts needed to complete a group of assemblies as well as provide a single, unique part needed to complete a unique assembly without causing an operator to delay in finding the needed part. This efficiency increases the number of completed assemblies per hour in a manufacturing setting.

In this non-limiting embodiment of the invention, the notification assembly 30 comprises the monitors 90, pager 103, and antenna 92. Additionally, the notification assembly 30 may comprise a communications interface assembly 100 which allows the material and/or component vendors 40 to be notified of needed components and assemblies 62, thereby allowing the vendors 40 to quickly respond to projected or future material needs.

Referring now to FIG. 4, in the most preferred embodiment of the invention, each monitor 90 graphically provides the material information by the use of icons 200 and each icon 200 has two different colors 202, 204 that “touch” or abut on no more than three and no less than two respective sides 206, 208. In this manner, workers 94 may distinguish more than 256 different types of icons upon each of the monitors 90.

Using the part flow information, the present invention produces an optimized production schedule based on the current operating practice, assembly plant schedule requirements, and available resources such as materials, components, available equipment and trained operators. In operation, customer orders 125 for various types of completed units or products, such as final product 86, are received by the computer system 28. These orders may be placed into a production/scheduling queue in a conventional manner. By way of example and without limitation, this queue may represent product orders which were received during some predetermined period of time and may initially group these orders by component type (e.g., orders for substantially the same type of final product 86 are contiguously grouped together in order to allow the manufacturing facility to sequentially produce the substantially similar products). The groupings may then be arranged in the order of greatest profit margin being produced first. In this non-limiting example, the group which the lowest overall profit margin is produced last. In this manner, groups are scheduled in an order which is dependent upon the respective profit margin (e.g., in a descending order of profit margin realization). For each type of produced item or good, such as good 86, the computer system 28 maintains a respective listing of all materials and components 62 necessary to produce that item or good. Other conventional and initial scheduling algorithms may also be used. In addition, the system allows for multiple unique inputs to be assembled onto the desired finished product. For example, it is expected that the plurality of parts, components and sub-components making up an entire automobile can be scheduled for inclusion onto a “custom ordered”0 vehicle in real time, from the time the customer places the order to the actual build of the vehicle. By monitoring available resources and notifying operators in advance of the needed parts, the present system provides notification and delivery of the needed parts in time, even if just a single one is necessary.

After the production schedule is completed according to some criteria and/or desired metrics, the computer system 28 reviews the amount and type of material and components 62 which are resident within the production facility 12 and initially determines whether sufficient amounts and types of such required materials and components 62 are available within the production facility 12. If sufficient amounts and types of materials and components 62 are available, the computer system 28 notifies the facility personnel that production is to be accomplished according to a certain schedule and allows the production to occur. If an insufficient amount of material and components 62 are available, the computer system 28 determines whether a sufficient amount of time exists before production begins to order and obtain such components and materials from the vendors 40. If sufficient time exists, computer system 28 automatically generates at least one material order, by use of interface portion 100, to at least one of the vendors 40. The order specifies the amount, type, and delivery requirements of the needed material 62. Additionally, the computer system 28 may determine that sufficient material and components 62 exist in order to begin production according to the initially developed schedule but that additional materials and components 62 are needed for desired goods 86 which are to be produced later in the schedule. In this situation, the computer 28 may allow production to begin and concomitantly order the “later needed” material from the vendors 40 provided that the computer system 28 determines that the material and components 62 may be obtained from the vendors by a required and/or desired date which allows production to occur according to the schedule.

During the production process, the computer system 28 continuously and/or periodically monitors the inventory levels of the material and components 62 within the production facility 12 in order to periodically and/or continuously ensure that sufficient amounts of materials and components 62 remain within the facility 12 in order to allow the production schedule to be desirably accomplished.

Importantly, should an unforeseeable event occur within the production facility 12 (e.g., a “breakdown” of a machine with a workstation 82, 84 which is necessary to create a desired type of final product 86), the computer system 28 modifies the production schedule according to some predetermined optimization weighing factors (e.g., ensuring that higher profit margin products can be built) and concomitantly ensures that the newly optimized production schedule may be accomplished by ensuring that the needed inventory or materials and components 62, necessary to complete the modified production schedule, are resident within the production facility 12. In this manner, the computer system 28 continues to optimize production according to the predetermined metrics or criteria.

The computer system 28, in one non-limiting embodiment of the invention, determines whether its commands are being accomplished by reviewing the component and material flow “through” the production facility 12 and by requiring personnel to provide the type of final good 86 which is sequentially produced, effective to allow the computer system 28 to compare its production schedule with the products which have actually been produced by the facility 12. That is, the computer system 28 determines which types of products 86 may be built without the “broken” machine and dynamically adjusts the production schedule to cause these types of products 86 to be built. Commands are then generated to the personnel 102, 94 informing them of the new schedule. The monitors 90 are updated to reflect the new schedule, on and by the computer 28 by use of assemblies 22, 24, 26 which verifies that such a schedule is being allowed. Moreover, the system 10 may also be adapted to resolve conflicts, by way of example and without limitation, by sensing the location of material by a first location and by using physical parameters of the system 12, such as conveyor speed to calculate the new location of the material 62.

The present invention has been described, by example, as a way for producing automotive components, assemblies or vehicles. It is to be understood that the present invention can be applied to manage any system having multiple variables to produce a desired, optimized output. It is to be further understood that the invention is not limited to the exact construction and method which has been illustrated and described above, but that various changes and modifications may be made without departing from the spirit and the scope of the inventions as are delineated in the following claims.

1. A complexity management system for managing a plurality of unique input variables and available resources to produce an optimized output, said complexity management system including:
a first portion which selectively generates a demand schedule;
a second portion which monitors said unique input variables and said available resources and which generates a signal to said first portion, based upon said monitoring of said input variables and available resources, effective to cause said demand schedule to be modified dynamically in a certain manner so as to optimize said output.

2. The complexity management system of claim 1 wherein said first portion comprises at least one computer.

3. The complexity management system of claim 2 wherein said second portion comprises at least one data acquisition assembly which is communicatively coupled to said first portion.

4. The complexity management system of claim 3 wherein said at least one data acquisition assembly acquires information on said available resources, said information comprising a location and quantity of said available resources.

5. The complexity management system of claim 2 wherein said first portion further comprises a notification assembly, said notification assembly being effective to communicate said modified demand schedule to said available resources.

6. The complexity management system of claim 5 wherein said notification assembly further comprises a communications interface assembly which is effective to communicate said modified demand schedule to a supplier of said available resources.

7. The complexity management system of claim 4 wherein the data acquisition assembly further includes at least one sensor tag which is physically disposed on said available resources.

8. The complexity management system of claim 7 wherein the at least one data acquisition assembly is operative to interrogate said at least one sensor tag for information.

9. The complexity management system of claim 8 wherein said at least one data acquisition assembly comprises at least one radio transmitter/receiver assembly.

10. The complexity management system of claim 9 wherein said at least one data acquisition assembly further comprises at least one tag reader.

11. A method for managing a plurality of unique input variables and available resources to produce a desired output, comprising the steps of:
creating a demand schedule;
monitoring said input variables and available resources; and
dynamically modifying said demand schedule in response to said monitoring of said input variables and available resources.

12. The method of claim 12 wherein said step of creating a demand schedule further comprises the steps of:
receiving desired orders;
grouping said desired orders in a certain priority; and
determining said demand scheduled based on said grouping.

13. The method of claim 11 wherein said step of dynamically modifying said demand schedule in response to said monitoring of said input variables and available resources further comprises the steps of:
comparing a desired quantity described in said desired orders to said determined quantity of said available resources;
re-grouping said desired orders in a second certain priority based on said comparison; and
determining said modified demand schedule based on said re-grouping.

14. The method of claim 13 wherein said step of dynamically modifying said demand schedule in response to said monitoring of said available resources further comprises the steps of notifying at least one resource supplier of said modified demand schedule.

15. A production optimization system for use with a production facility of the type which is adapted to create products by the use of certain materials and certain production assemblies, said production optimization system includes:
a first portion which selectively generates a production schedule;
a second portion which monitors said production assemblies and said materials and which generates a signal to said first portion, based upon said monitoring of said production assemblies and said materials, effective to cause said production schedule to be modified in a certain manner.

16. The production optimization system of claim 15 wherein said first portion comprises at least one computer.

17. The production optimization system of claim 16 wherein said second portion comprises at least one data acquisition assembly which is communicatively coupled to said first portion.

18. The production optimization system of claim 17 wherein said at least one data acquisition assembly acquires information on said materials, said information comprising a location of said materials and a quantity of said materials.

19. The production optimization system of claim 16 wherein said first portion further comprises a notification assembly, said notification assembly being effective to communicate said modified production schedule to said certain production assemblies.

20. The production optimization system of claim 19 wherein said notification assembly further comprises a communications interface assembly which is effective to communicate said modified production schedule to a vendor of said materials.

21. A production optimization system for use with a production facility comprising a material inventory assembly, a material transport assembly, and a manufacturing assembly, said production optimization system comprising:
a computer system which is capable of receiving customer orders and which determines a production schedule based on said customer orders;
at least one sensor tag which is physically disposed on materials and components within said production facility;
at least one data acquisition assembly which interrogates said at least one sensor tag for information and which is communicatively coupled to said computer system; and
a notification assembly which is communicatively coupled to said computer system, said material inventory assembly, said material transport assembly, and said manufacturing assembly.

22. The production optimization system of claim 21 wherein said at least one data acquisition assembly comprises at least one radio transmitter/receiver assembly.

23. The production optimization system of claim 22 wherein said at least one data acquisition assembly further comprises at least one tag reader.

24. The production optimization system of claim 21 wherein said notification assembly comprises at least one display which is disposed in said manufacturing assembly.

25. The production optimization system of claim 24 wherein said notification assembly creates at least one icon having a first colored portion and a second colored portion which abut on at least two but no more than three sides.

26. A method for producing products by the use of various materials and assemblies, said method includes the steps of:
creating a production schedule;
monitoring said materials and said assemblies; and
dynamically modifying said production schedule in response to said monitoring of said materials and said assemblies.

27. The method of claim 26 wherein said step of creating a production further comprises the steps of:
receiving customer orders;
grouping said customer orders in a certain priority; and
determining said production scheduled based on said grouping.

28. The method of claim 27 wherein said step of monitoring said materials and said assemblies further comprises the steps of:
determining a location of said materials; and
determining a quantity of said materials.

29. The method of claim 28 wherein said step of monitoring said materials and said assemblies further comprises the step of determining the operational status of said assemblies.

30. The method of claim 29 wherein said step of dynamically modifying said production schedule in response to said monitoring of said materials and said assemblies further comprises the steps of:
comparing a desired quantity described in said customer orders to said determined quantity of said materials;
re-grouping said customer orders in a second certain priority based on said comparison; and
determining said modified production schedule based on said re-grouping.

31. The method of claim 30 wherein said step of dynamically modifying said production schedule in response to said monitoring of said materials and said assemblies further comprises the steps of:
notifying at least one assembly employee of said modified production schedule; and
notifying at least one material transport employee of said modified production schedule.

32. The method of claim 31 wherein said step of dynamically modifying said production schedule in response to said monitoring of said materials and said assemblies further comprises the steps of notifying at least one material supplier of said modified production schedule.

33. The method of claim 26 wherein said step of monitoring said materials and said assemblies comprises:
monitoring said production schedule;
receiving a quantity of a final product type from at least one manufacturing employee; and
determining whether said quantity matches said production schedule.

34. The method of claim 26 further comprising the step of selectively ordering at least one of said materials in response to said monitoring of said materials.
